(19) United States
(12) Patent Application Publication
(10) Pub. No.: US 2014/0215346 A1
(43) Pub. Date: Jul. 31, 2014

(54) ADDRESS ENTRY LIST VALUES

(71) Applicant: ORACLE INTERNATIONAL CORPORATION, Redwood Shores, CA (US)

(72) Inventors: DHAVAL MANHARLAL MEHTA, BELMONT, CA (US); KISHORE BALLA, SAN MATEO, CA (US); INDRAJIT SEN, SAN RAMON, CA (US)

(73) Assignee: ORACLE INTERNATIONAL CORPORATION, REDWOOD SHORES, CA (US)

(21) Appl. No.: 13/751,699

(22) Filed: Jan. 28, 2013

(51) Int. Cl. H04L 12/24

(52) U.S. Cl. CPC H04L 41/22
USPC 715/739

(57) ABSTRACT

Embodiments of the invention provide systems and methods for configuring and using an enhanced address List of Values (LOV). According to one embodiment, configuring and using an enhanced address List of Values (LOV) can comprise installing, by a computer system, an application using address information. The address information can have a predefined format for a plurality of geographic regions relevant to the application. The address LOV can be configured by the computer system for a selected geographic region from the plurality of geographic regions relevant to the application and the configured address LOV and used by the computer system in a user interface of the application to define values for attributes related to entry of an address within the selected geographic region.

### BACKGROUND OF THE INVENTION

Embodiments of the present invention relate generally to methods and systems for configuring and using available values for attributes of application data and more particularly to configuring an address List of Values (LOV) and using the configured and enhanced address LOV in a user interface for selecting or defining values of address-related attributes.

Various applications of different types rely on and use address information for customers, suppliers or vendors, employees, contractors, patients, and other persons or entities. For example, accurate address entry is important for enterprise applications so that the billing, shipping, selling, marketing, tax, and other activities are done correctly. Many times, applications rely on the data entry done by the users. Some applications enforce certain pre-defined address validation rules but they are limited to just the United States or one specific country. Additionally, current applications are provided with a predefined list of value for only a limited set, for example States in the United States and not comprehensive for all the levels like city, postal code, other countries etc. Hence, there is a need for improved methods and systems for configuring and using an enhanced address LOV.

### BRIEF SUMMARY OF THE INVENTION

Embodiments of the invention provide systems and methods for configuring and using an enhanced address List of Values (LOV). According to one embodiment, configuring and using an enhanced address List of Values (LOV) can comprise installing, by a computer system, an application using address information. The address information can have a predefined format for a plurality of geographic regions relevant to the application. The address LOV can be configured by the computer system for a selected geographic region from the plurality of geographic regions relevant to the application and the configured address LOV and used by the computer system in a user interface of the application to define values for attributes related to entry of an address within the selected geographic region.

Configuring the address LOV for the selected geographic region can comprise obtaining geographic information specific to the selected geographic region and associating the obtained geographic information to the address LOV for the selected geographic region. A set of predefined configuration information for the address LOV can be read and a configuration user interface can be presented by the computer system proving at least some of the obtained geographic information and predefined configuration information. One or more updates to the configuration information can be received by the computer system through the user interface. The one or more updates to the configuration information can comprise updates to one or more defined fields for the address LOV, defined styles for the address LOV, alternate names for values of attributes in the address LOV, mappings of the geographic data to attributes in the address LOV, an auto-populate function, or a filter function. The one or more updates to the configuration information can be stored by the computer system.

Using the configured address LOV in the user interface of the application to define values for attributes related to entry of an address within the selected geographic region can comprise reading the stored configuration information and the geographic information for the selected geographic region. The user interface can be generated and displayed based on the configuration information and the geographic information. The user interface can include one or more indications of address attributes and an associated control allowing selection of a value from the address LOV for the associated address attribute. In some cases, an indication of one or more selected values from the address LOV and a request for a search can be received by the computer system through the user interface. In response to the request, the search can be performed based on the one or more selected values from the address LOV. Additionally or alternatively, a portion of a value of the address LOV can be received by the computer system through the user interface. In response to receiving the portion of the value, one or more suggestions can be provided for completing the value of the address LOV. The one or more suggestions can be filtered based on the received portion of the value and any other received values from the address LOV. Additionally or alternatively, a selection of a value for one of the attributes associated to the address LOV can be received by the computer system through the user interface. In response to receiving the selection, the values of one or more attributes associated to address LOV other than the attribute associated to the selected value can be populated.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for configuring and using an enhanced address List of Values (LOV) according to one embodiment of the present invention.

FIG. 4 is a screenshot illustrating a portion of an exemplary user interface of an application using an address LOV according to one embodiment of the present invention.

FIG. 5 is a screenshot illustrating a portion of an exemplary user interface for performing a geography setup according to one embodiment of the present invention.

FIG. 6 is a screenshot illustrating a portion of an exemplary user interface for defining primary and alternate names according to one embodiment of the present invention.

FIGS. 7A and 7B are screenshots illustrating portions of an exemplary user interface for defining geography mapping and address style definition according to one embodiment of the present invention.

FIGS. 8A and 8B are screenshots illustrating portions of another exemplary user interface using an address LOV and including filtering of values according to one embodiment of the present invention.

FIGS. 9A-9C are screenshots illustrating portions of an exemplary user interface using an address LOV according to one embodiment of the present invention.

FIGS. 10A and 10B are screenshots illustrating portions of an exemplary user interface using an address LOV and including filtering of values according to one embodiment of the present invention.

FIGS. 11A and 11B are screenshots illustrating portions of an exemplary user interface using an address LOV and including a search popup according to one embodiment of the present invention.

FIG. 12 is a flowchart illustrating an exemplary process for configuring an address LOV according to one embodiment of the present invention.

FIG. 13 is a flowchart illustrating an exemplary process for using an address LOV according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for configuring an address List of Values (LOV) and using the configured and enhanced address LOV in a user interface for selecting or defining values of address-related attributes. Embodiments of the present invention provide for a configurable address LOV for all countries and for any geography level in a given country structure based on setup and configuration. Embodiments of the present invention can also include, but are not limited to, an ability to configure what level the LOV should be enabled, an ability to configure for what country the LOV should be enabled, and ability to quickly pick values when LOV is enabled via enhanced usability features like smart list and auto-suggest during address entry. This configurability gives control to the administrator or other user of the application on how much and at what level they want to enforce the address LOVs. Various additional details of embodiments of the present invention will be described below with reference to the figures.

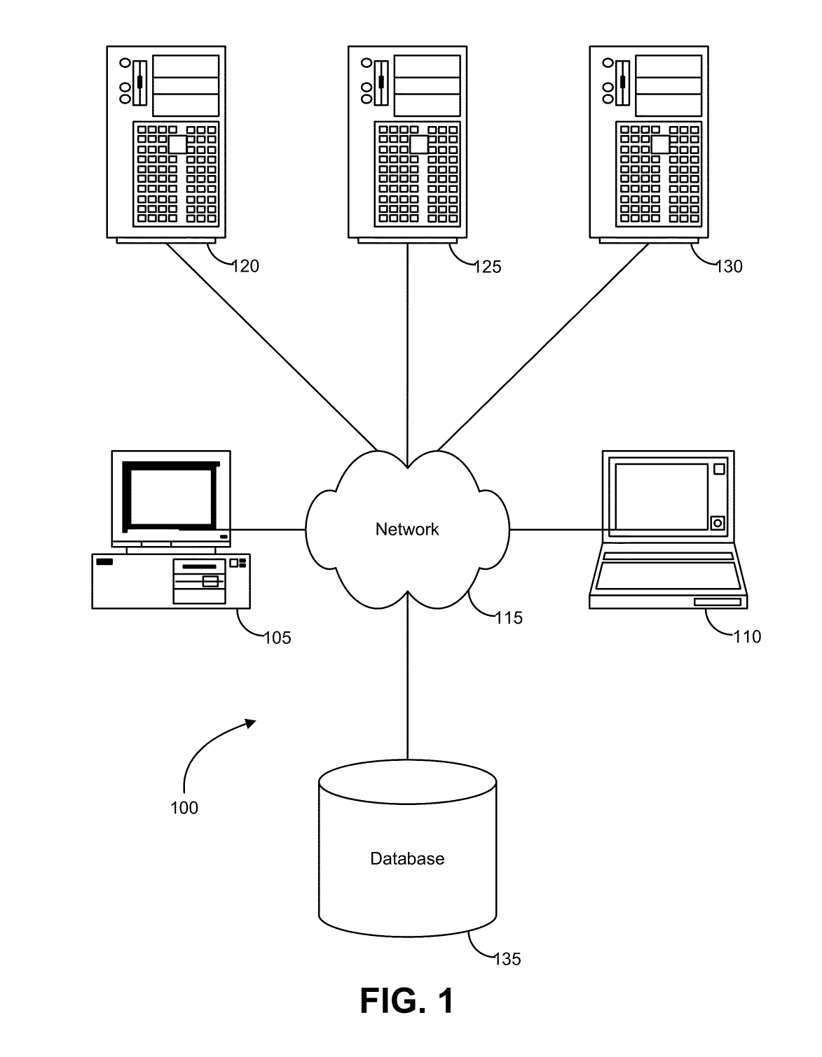

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

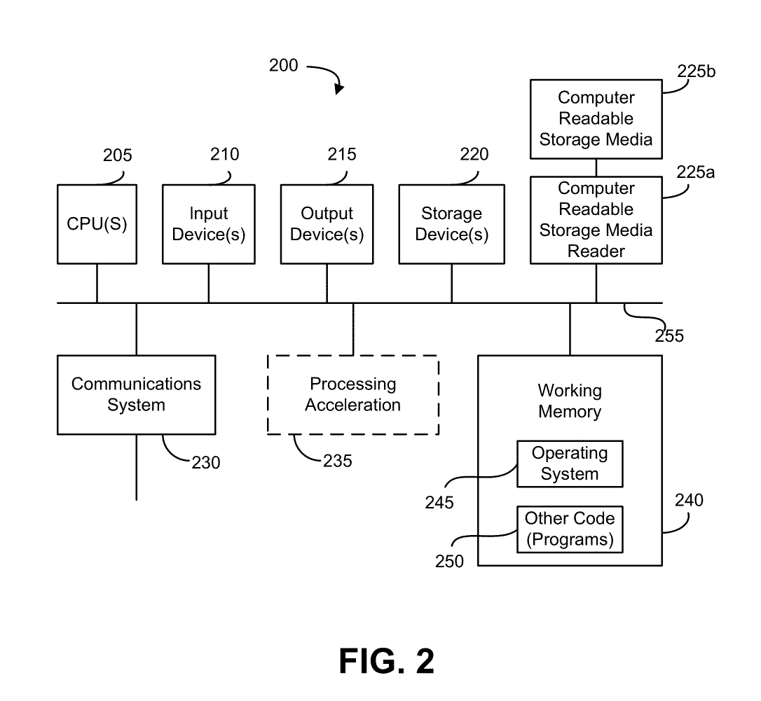

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

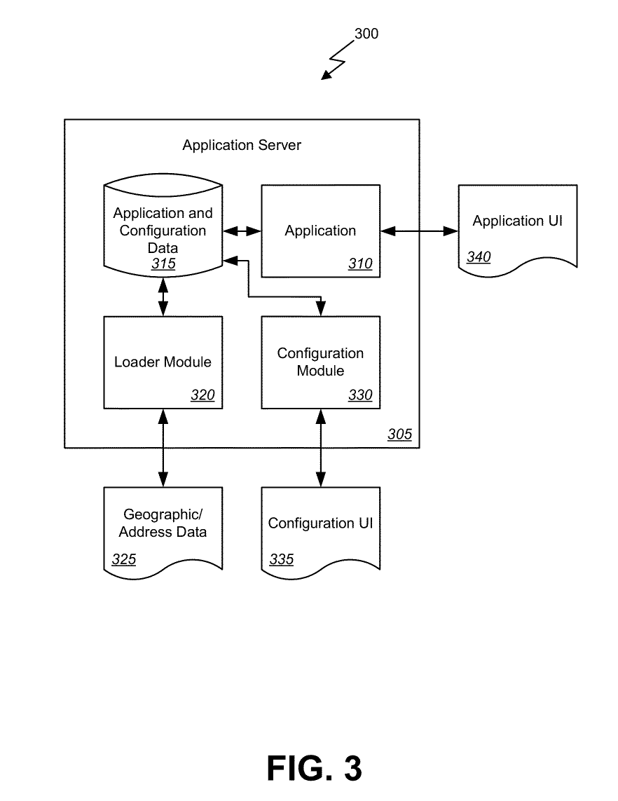

FIG. 3 is a block diagram illustrating, at a high-level, functional components of a system for configuring and using an enhanced address List of Values (LOV) according to one embodiment of the present invention. In this example, the system 300 can include an application server 305 or other computer system such as described above. The application server 305 can have installed thereon one or more applications 310 such as, for example, enterprise applications or an enterprise application suite. Such applications can include, but are not limited to, a Customer Relationship Management (CRM) application, a Human Resources Management (HRM) application, a Supply Chain Management (SCM) application, a financials application, a project management application, etc. Such applications 310 can maintain and utilize a set of application and configuration data 315 of different types and for different purposes, some of which will be described in detail below. Upon execution and using such data 315, the application 310 can generate and provide to a user a user interface 340 such as one or more webpages. Depending upon functions being performed by the application 310, the interface 340 can include a number of elements related to displaying and or defining an address. For example, the interface 340 can include elements such as text identifying an attribute related to an address, e.g., “City,” “State,” “Zip Code” etc., and a control such as a choice list for selecting a value from a List of Value (LOV) associated to these attributes. Examples of such interfaces will be described in greater detail below.

According to one embodiment, the application and configuration data 315 can include data defining different styles for these elements for different countries. This pre-defined configuration data can include, for example, metadata used by the application 310 in configuring the user interface 340 when displaying an address to use a particular format etc. According to one embodiment, the application server 305 can also have installed thereon, either separate from or as part of the application 310, a loader 320. The loader 320 can be adapted to import LOV data for a give country (i.e., geographic data). For example, such data can be purchased from a vendor that provides postal/geographic data for a given region in the form of a list of name/value pairs defining addresses and/or other geographic information within that region. Upon request or perhaps automatically, for example upon installation or an upgrade to the application 310, the loader 320 can access such a service, obtain the geographic data 325 and uses this data 325 to populate tables in the application and configuration data 315.

According to one embodiment, the application server 305 may also have installed thereon, either separate from or as part of the application 310, a configuration module 330. When executed, the configuration module 330 can generate and present to an administrator or other user of the application 310 a configuration user interface 335 such as one or more webpages, examples of which are described below. Generally speaking, through the configuration user interface 335, the administrator or other user of the application 310 can define fields and LOVs based on the imported geographic data and otherwise define and/or configure the address LOVs and use thereof by the application 310 in the application user interface 340.

For example, through the configuration interface 335 and configuration module 330, an administrator or other user can configure attributes for a given country relevant to the application 310 and for a given attribute, whether the LOV for that attribute should be presented in the application user interface 340. Additionally or alternatively, the administrator or other user may configure an auto-populate function, e.g., when a user of the application interface 340 selects a lower level value or a value associated to an address attribute that is more specific, the application 310 can auto-populate higher level, i.e., less specific, values or vice versa. So for example, when a user of the application interface 340 selects a city through a presented LOV, the application 310 can auto-populate a value for a state attribute based on the stored data 315 and presented LOVs or when the user selects a state, the application 310 can fill and/or filter an available LOV for a city attribute.

According to one embodiment, based on the application and configuration data 315, i.e., based on the imported geographic data and configuration data, a choice list LOV can be included in the application interface 340 that can include a smart list of values, that user can quickly select from. That is, through such a list the user does not need to click Search in an LOV to select a value from the LOV. Rather, the LOV can be rendered with relevant/filtered values. In other words, a “smart list” can be provided where the complete list can be filtered by parent geography already selected.

Additionally or alternatively, functions provided by the application 310 through the user interface 340 and using the address LOV can include a suggestion list for an auto-complete function. For example, when a user is typing a zip code value in a field associated with that attribute, following digits of the zip code value can be auto suggested, i.e., filtered on already entered attributes and received values. This auto-complete function can be configurable by metadata defined through the configuration user interface 335 and configuration module 330 and stored in the configuration data 315 for the application 310. The application user interface 340 can then be presented dynamically based on this configuration and current use of the application 310 and interface 340.

Additionally or alternatively, functions provided by the application 310 through the user interface 340 and using the address LOV can include a smart search that offers an option to the user at each geographic level when they click search in the address LOV. Such a search function can provide for searching any geography but, for example, may be limited by a parent attribute of the list if one is already selected. This LOV search can, for example, return a geography for a given country at a given level, in a predefined primary or alternate language.

Additionally or alternatively, functions provided by the application 310 through the user interface 340 and using the address LOV can include an ability to define and use an alternate geographic name, e.g., US for United States, CA for California, etc. In such cases, a user can enter, search, and select a name of a given geography, whether it is primary, or alternate. This function provides a way to the users to enter a different name than the primary name of the geography, when appropriate and allow the user to search and capture alternate geography name, either from LOV search or by typing directly in the form field. The primary name need not replace the alternate name if an alternate name is already entered and it is a valid value in the address LOV.

Additionally or alternatively, functions provided by the application 310 through the user interface 340 and using the address LOV can include an auto-populate function. That is, when a value of one attribute is selected from the address LOV, the values of other attributes can be populated or filtered automatically based on the selected value. For example, upon the user selecting a child geography from the address LOV in the user interface 340, parent geographies therein can be populated by primary name if the parents are not already selected i.e., they are null, or parents already selected are wrong based on the child selection. Alternatively, upon selection of a value for a parent attribute, possible values presented in the address LOV for child attributes can be filtered based on selection of the parent.

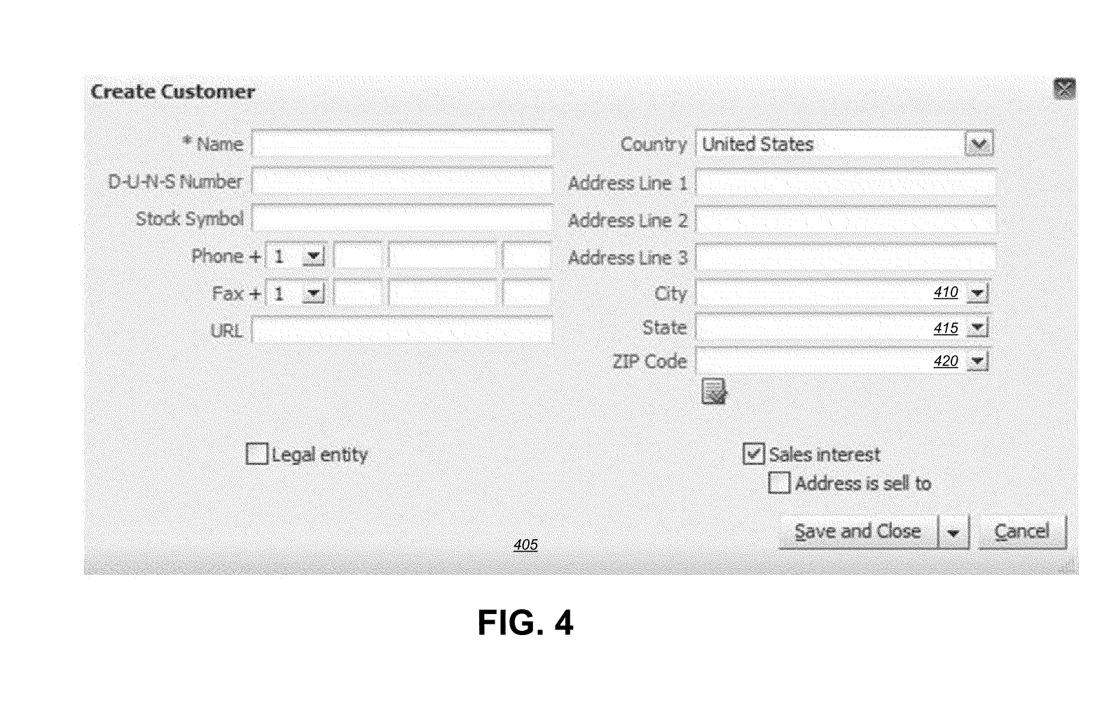

Stated another way, configuring and using an enhanced address LOV can begin with installing an application 310 using address information 315. The address information 315 can have a predefined format defined by the application 310 for a plurality of geographic regions relevant to the application 310. However, the address LOV can be configured for a selected geographic region from the plurality of geographic regions relevant to the application 310 as will be described below. Once configured, the address LOV can be used in a user interface 340 of the application 310 to define values for attributes related to entry of an address within the selected geographic region as illustrated in and as will be described below with reference to FIG. 4 or 8-11.

Configuring the address LOV for the selected geographic region can comprise the loader module 320 loading a set of geographic data 325. Loading the geographic data 325 can comprise obtaining geographic information specific to the selected geographic region from a provider. For example, any of a number of known third-party providers of such information can be used to obtain such geographic data for a relevant or desired region. The obtained geographic data can be associated to the address LOV for the selected geographic region. Configuring the address LOV for the selected geographic region by the configuration module 330 can optionally further comprise reading any available predefined configuration information for the address LOV from the application data 315.

Once the geographic data 325 has been loaded and configuration data 315 (if any) has been read by the configuration module 330, configuring the address LOV for the selected geographic region can further comprise presenting a configuration user interface 335, such as will be described below, proving at least some of the obtained geographic information and predefined configuration information and through which a user can change or define configuration of the address LOV. One or more updates to the configuration information can be received through this user interface 335. For example, the one or more updates to the configuration information can comprise updates to one or more of defined fields for the address LOV, defined styles for the address LOV, alternate names for values of attributes in the address LOV, mappings of the geographic data to attributes in the address LOV, an auto-populate function, a filter function, etc. The one or more updates to the configuration information can be stored by the configuration module 330 in the application and configuration data 315 and the configured address LOV can be made available and used in user interfaces 340 of the application 310.

Using the configured address LOV in the user interface 340 of the application 310, to define values for attributes related to entry of an address within the selected geographic region can comprise reading the stored configuration information and the geographic information for the selected geographic region. The user interface 340 can be generated based on the configuration information 315 and the geographic information 325 and displayed. As will be described below with reference to FIGS. 4 and 8-11, the user interface 340 can include one or more indications of address attributes and an associated control allowing selection of a value from the address LOV for the associated address attribute. Depending on the functions and features of the application 310 exposed through this interface 340, a number of different functions might be accessible through this user interface.

For example, using the configured address LOV in the user interface 340 of the application 310 to define values for attributes related to entry of an address within the selected geographic region may comprise receiving an indication of one or more selected values from the address LOV and a request for a search. In response to the request, the application 310 perform the search based on the one or more selected values from the address LOV. In another example, using the configured address LOV in the user interface 340 of the application 310 to define values for attributes related to entry of an address within the selected geographic region further may comprise receiving a portion of a value of the address LOV. In response to receiving the portion of the value, the application 310 can provide, by updating the user interface 340, one or more suggestions for completing the value of the address LOV. In such cases, the one or more suggestions can be filtered by the application 310 based on the received portion of the value and any other received values from the address LOV. In yet another example, using the configured address LOV in the user interface 340 of the application 310 to define values for attributes related to entry of an address within the selected geographic region may comprise receiving a selection of a value for one of the attributes associated to the address LOV. In response to receiving the selection, the application 310 can update the user interface 340 to populate the values of one or more attributes associated to address LOV other than the attribute associated to the selected value. Other functions and uses based on the address LOV as described herein are contemplated and considered to be within the scope of the present invention.

To further illustrate these processes, a set of exemplary user interfaces are provided and described below. However, it should be understood that the interfaces illustrated and described here are offered only by way of example and are not intended to limit the scope of the present invention. Rather, depending upon the exact implementation, the contents and format of the user interfaces can vary significantly without departing from the scope of the present invention.

FIG. 4 is a screenshot illustrating a portion of an exemplary user interface of an application using an address LOV according to one embodiment of the present invention. Embodiments of the present invention can be exposed in flows of the application like a “create customer” process which may present a user interface page 405 as illustrated here. This page can include, for example, a number of elements 410, 415, and 420 for selecting values of address attributes from the address LOV. As illustrated here, these elements 410, 415, and 420 may be displayed with text such as “City,” “State,” “ZIP Code,” etc. identifying the address attributes associated to those values.

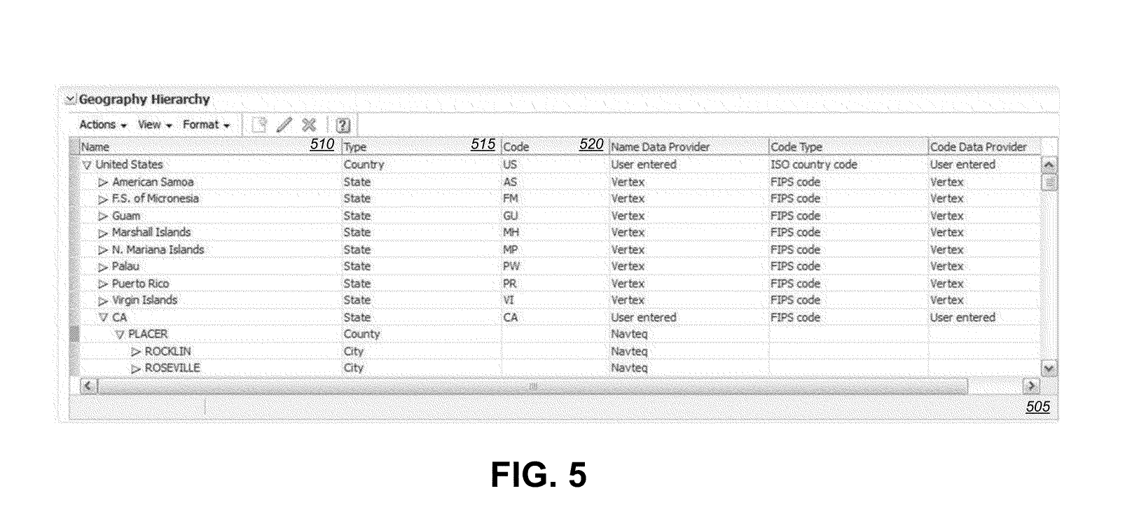

FIG. 5 is a screenshot illustrating a portion of an exemplary user interface for performing a geography setup according to one embodiment of the present invention. This example illustrates a page 505 which can be presented to an administrator or user to allow geography data for each country, region, or other area to be created using. For example, this page 505 can present a number of attributes related to that geographic region such as a name 510, type 515, code 520 or abbreviation, etc. and can allow the user to select or define values for those attributes.

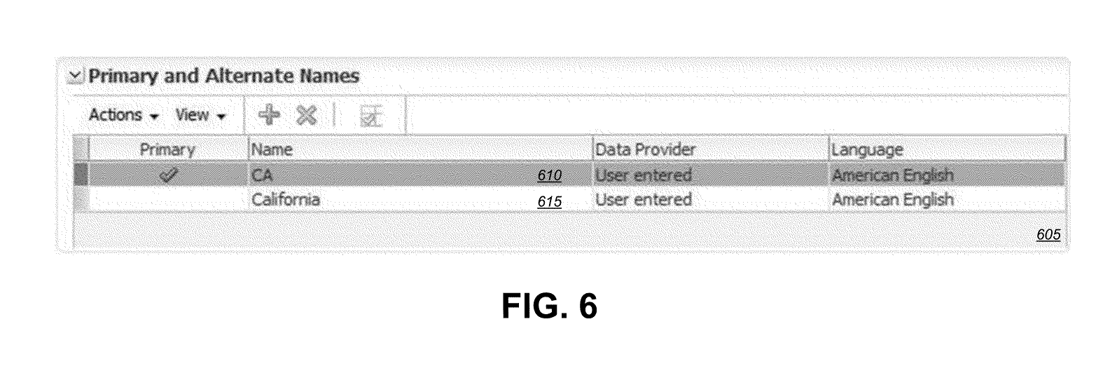

FIG. 6 is a screenshot illustrating a portion of an exemplary user interface for defining primary and alternate names according to one embodiment of the present invention. As noted above, given geographies can be assigned alternate names. This example illustrates a page 605 through which a primary name 610 and one or more alternate names 615 can be defined by an administrator or other user.

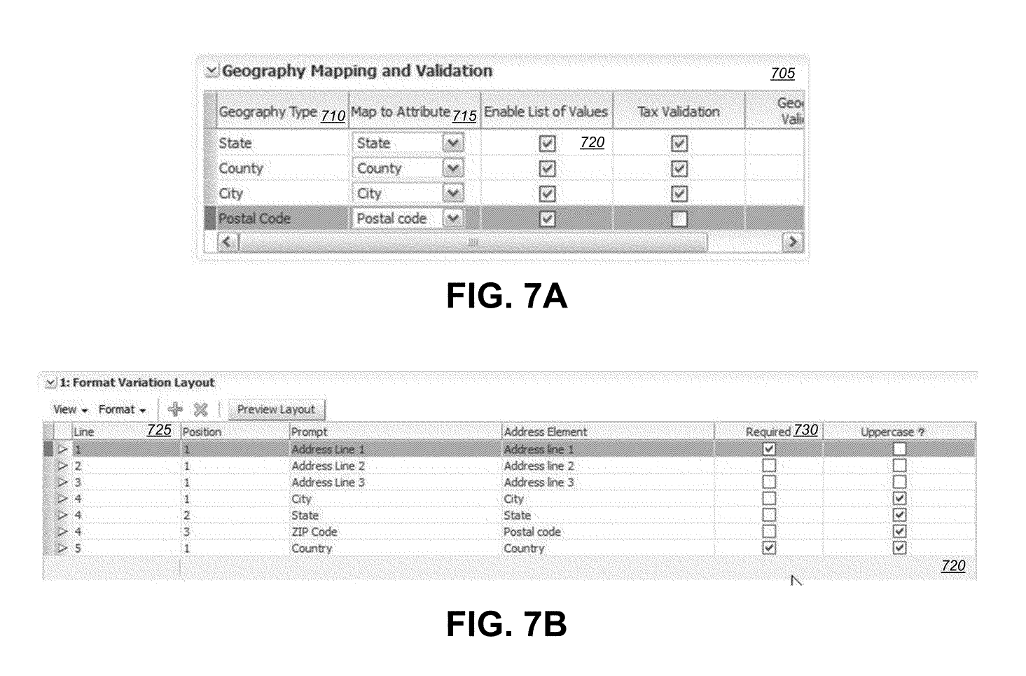

FIGS. 7A and 7B are screenshots illustrating portions of an exemplary user interface for defining geography mapping and address style definition according to one embodiment of the present invention. Generally speaking, geography mapping allows an administrator or other user to enable address LOVs for address attributes. Style format allows the administrator or other user to select what fields should be exposed in the user interface of the application. The example of FIG. 7A illustrates a page 705 for defining geography mapping through which a particular geography type 710 can be mapped to a particular attribute 715 and an associated LOV can be enabled 720 for that attribute. FIG. 7B illustrates an example of a page 720 through which an interface layout can be defined for a particular line 725 of a page, whether that attribute is a required field 730, etc.

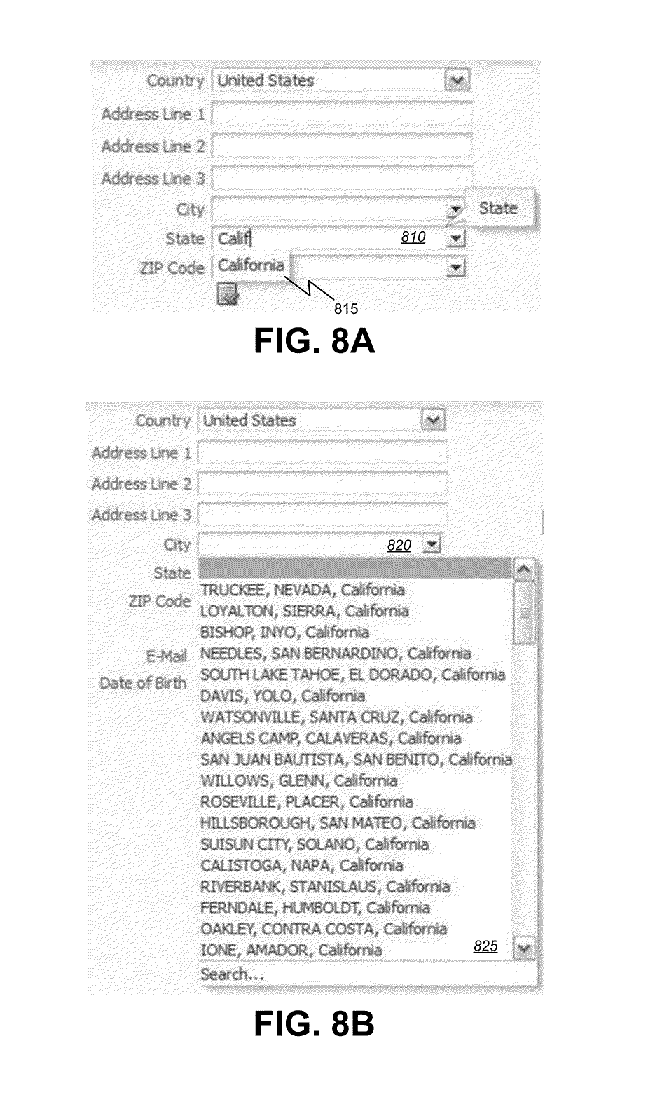

FIGS. 8A and 8B are screenshots illustrating portions of another exemplary user interface using an address LOV and including filtering of values according to one embodiment of the present invention. When a value for parent geography such as the “State” attribute 810 is selected, then a value for a child geography such as the “City” attribute 820 can be filtered based on the selected value of the parent attribute and the filtered LOV 825 can be presented for selection of a value of the child attribute. Additionally as illustrated here, if an alternate name is selected for a value of the parent attribute 810, an auto-suggest function can provide a suggestion 815 for completion of that value.

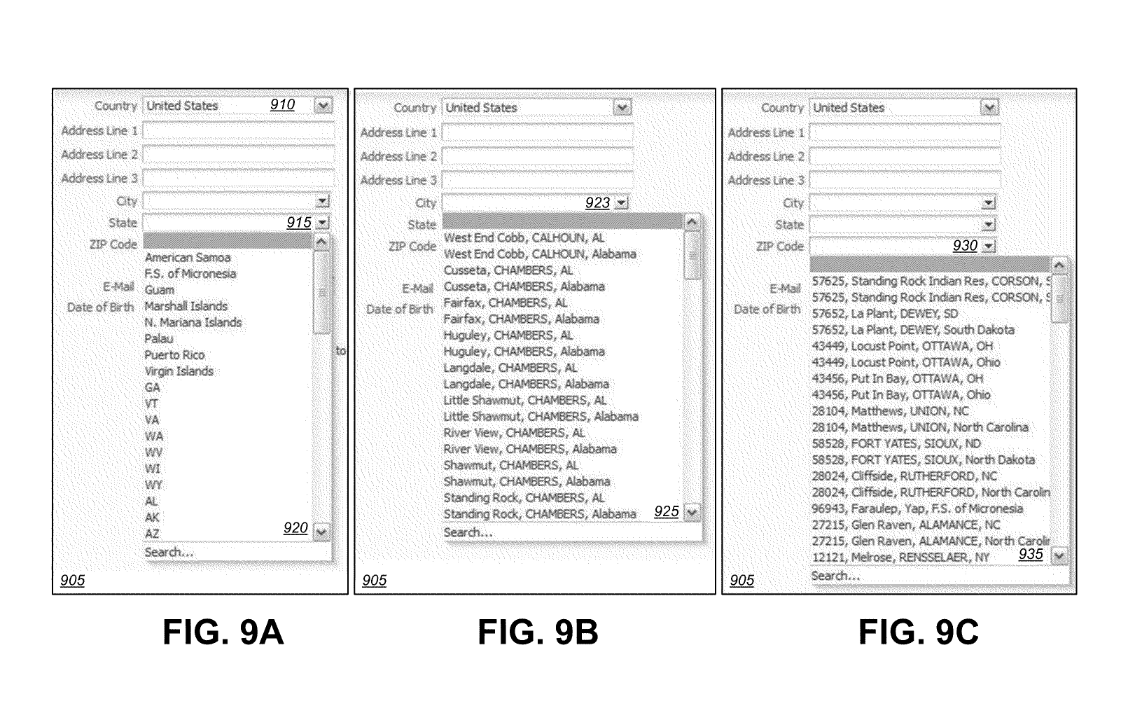

FIGS. 9A-9C are screenshots illustrating portions of an exemplary user interface using an address LOV according to one embodiment of the present invention. These examples illustrate a page 905 or portion of a user interface in which a value 910 for a “Country” attribute has been selected. Based on this selection, values for the child attributes can be filtered. For example and as illustrated in FIG. 9A, the “State” attribute 915 can be filtered based on selection of the “Country” value 910 and the filtered LOV 920 can be presented for selection of a value for the “State” attribute. Similarly and as illustrated in FIG. 9C, the “ZIP Code” attribute 930 can be filtered based on selection of the “Country” value 910 and the filtered LOV 935 can be presented for selection of a value for the “ZIP Code” attribute. As illustrated in the example of FIG. 9B, selection of a value of a child attribute such as the “State” attribute or “ZIP Code attribute can also filter the values for a parent attribute. In this case, the “City” attribute 923 can be filtered and the filtered LOV 925 can be presented for selection of a value for the “City” attribute.

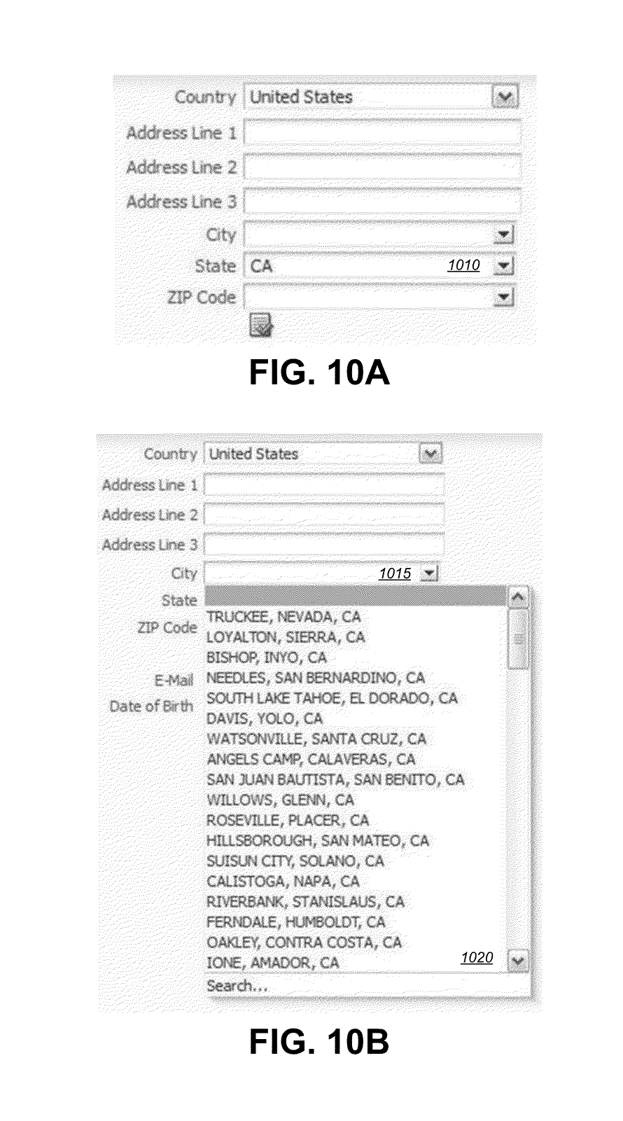

FIGS. 10A and 10B are screenshots illustrating portions of an exemplary user interface using an address LOV and including filtering of values according to one embodiment of the present invention. As illustrated here, when a value for parent geography such as the “State” attribute 1010 is selected, then a value for a child geography such as the “City” attribute 1015 can be filtered based on the selected value of the parent attribute and the filtered LOV 1020 can be presented for selection of a value of the child attribute.

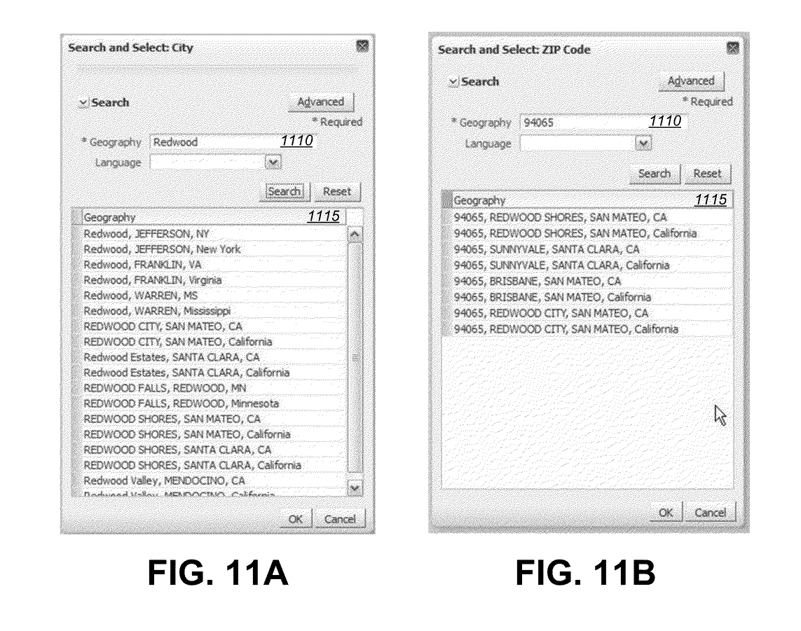

FIGS. 11A and 11B are screenshots illustrating portions of an exemplary user interface using an address LOV and including a search popup according to one embodiment of the present invention. According to one embodiment, address entry can be done with search popup 1105. In the examples illustrated here, a geography value 1110 such as a city name as in FIG. 11A or zip code as in FIG. 11B can be entered in the popup 1105. Accordingly, a filtered list 1115 of results for that geography can be returned for selection of a value for the attribute searched.

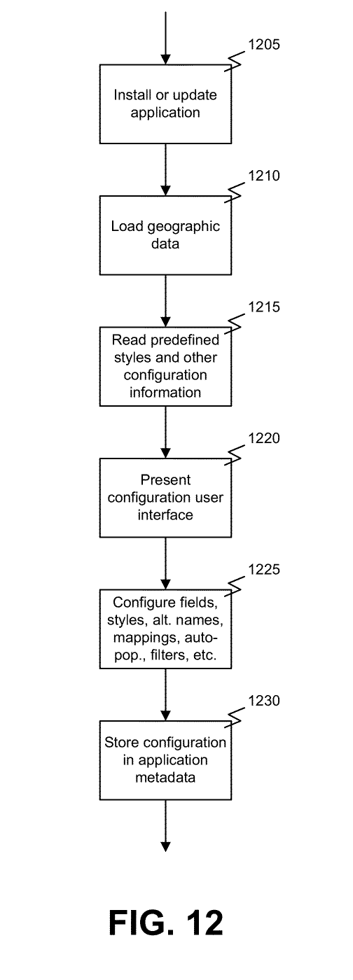

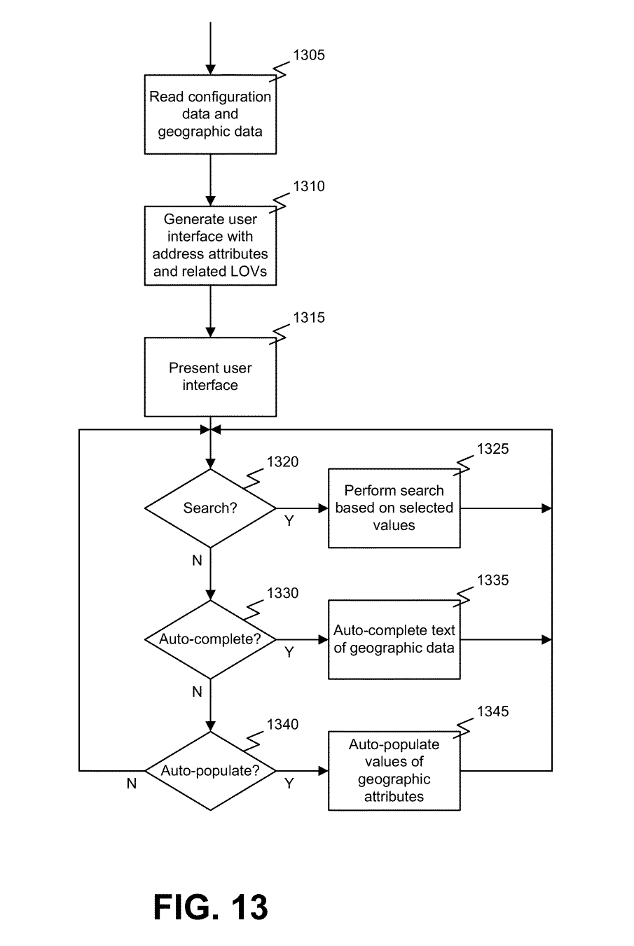

FIG. 12 is a flowchart illustrating an exemplary process for configuring an address LOV according to one embodiment of the present invention. In this example, configuring and using an enhanced address LOV can begin with installing 1205 an application using address information. The address information can have a predefined format defined by the application for a plurality of geographic regions relevant to the application. However, the address LOV can be configured 1210-1230 for a selected geographic region from the plurality of geographic regions relevant to the application as will be described below. Once configured 1210-1230, can be used in a user interface of the application to define values for attributes related to entry of an address within the selected geographic region as illustrated and described above with reference to FIG. 4 or 8-11 and as will be described below with reference to FIG. 13.

As illustrated in FIG. 12, configuring the address LOV for the selected geographic region can comprise loading 1210 a set of geographic data. As noted above, loading 1210 the geographic data can comprise obtaining geographic information specific to the selected geographic region from a provider and associating the obtained geographic information to the address LOV for the selected geographic region. Configuring the address LOV for the selected geographic region can further comprise reading 1215 a set of predefined configuration information for the address LOV.

Once the geographic data has been loaded 1210 and configuration data (if any) has been read 1215, configuring the address LOV for the selected geographic region can further comprise presenting 1220 a configuration user interface, such as described above, proving at least some of the obtained geographic information and predefined configuration information and through which a user can change or define configuration of the address LOV. One or more updates to the configuration information can be received 1225 through this user interface. For example, the one or more updates to the configuration information can comprise updates to one or more of defined fields for the address LOV, defined styles for the address LOV, alternate names for values of attributes in the address LOV, mappings of the geographic data to attributes in the address LOV, an auto-populate function, a filter function, etc. The one or more updates to the configuration information can be stored 1230 and the configured address LOV can be made available and used in user interfaces of the application.

FIG. 13 is a flowchart illustrating an exemplary process for using an address LOV according to one embodiment of the present invention. In this example, using the configured address LOV in the user interface of the application, such as described above and illustrated for example in FIG. 4 or 8-11 to define values for attributes related to entry of an address within the selected geographic region can comprise reading 1305 the stored configuration information and the geographic information for the selected geographic region. The user interface can be generated 1310 based on the configuration information and the geographic information and displayed 1315. As noted above, the user interface can include one or more indications of address attributes and an associated control allowing selection of a value from the address LOV for the associated address attribute. Depending on the functions and features of the application exposed through this interface, a number of different functions 1320-1345 might be accessible through this user interface.

For example, using the configured address LOV in the user interface of the application to define values for attributes related to entry of an address within the selected geographic region may comprise receiving an indication of one or more selected values from the address LOV and a request for a search. In response to the request 1320, the search can be performed 1325 based on the one or more selected values from the address LOV. In another example, using the configured address LOV in the user interface of the application to define values for attributes related to entry of an address within the selected geographic region further may comprise receiving a portion of a value of the address LOV. In response to receiving the portion of the value 1330, one or more suggestions for completing the value of the address LOV can be provided 1335. In such cases, the one or more suggestions can be filtered based on the received portion of the value and any other received values from the address LOV. In yet another example, using the configured address LOV in the user interface of the application to define values for attributes related to entry of an address within the selected geographic region may comprise receiving a selection of a value for one of the attributes associated to the address LOV. In response to receiving the selection 1340, the values of one or more attributes associated to address LOV other than the attribute associated to the selected value can be populated 1345. Other functions and uses based on the address LOV as described herein are contemplated and considered to be within the scope of the present invention.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for configuring and using an enhanced address List of Values (LOV), the method comprising:
installing, by a computer system, an application using address information, the address information having a predefined format for a plurality of geographic regions relevant to the application;
configuring, by the computer system, the address LOV for a selected geographic region from the plurality of geographic regions relevant to the application; and
using, by the computer system, the configured address LOV in a user interface of the application to define values for attributes related to entry of an address within the selected geographic region.

2. The method of claim 1, wherein configuring the address LOV for the selected geographic region comprises:
obtaining geographic information specific to the selected geographic region; and
associating the obtained geographic information to the address LOV for the selected geographic region.

3. The method of claim 2, wherein configuring the address LOV for the selected geographic region further comprises reading a set of predefined configuration information for the address LOV.

4. The method of claim 3, wherein configuring the address LOV for the selected geographic region further comprises:
presenting, by the computer system, a configuration user interface proving at least some of the obtained geographic information and predefined configuration information;
receiving, by the computer system through the user interface, one or more updates to the configuration information; and
storing, by the computer system, the one or more updates to the configuration information.

5. The method of claim 4, wherein the one or more updates to the configuration information comprise updates to one or more of defined fields for the address LOV, defined styles for the address LOV, alternate names for values of attributes in the address LOV, mappings of the geographic data to attributes in the address LOV, an auto-populate function, or a filter function.

6. The method of claim 5, wherein using the configured address LOV in the user interface of the application to define values for attributes related to entry of an address within the selected geographic region comprises:
reading the stored configuration information and the geographic information for the selected geographic region;
generating the user interface based on the configuration information and the geographic information, the user interface including one or more indications of address attributes and an associated control allowing selection of a value from the address LOV for the associated address attribute; and
displaying the generated user interface,

7. The method of claim 6, wherein using the configured address LOV in the user interface of the application to define values for attributes related to entry of an address within the selected geographic region further comprises:
receiving, by the computer system through the user interface, an indication of one or more selected values from the address LOV and a request for a search; and
in response to the request, performing the search based on the one or more selected values from the address LOV.

8. The method of claim 6, wherein using the configured address LOV in the user interface of the application to define values for attributes related to entry of an address within the selected geographic region further comprises:
receiving, by the computer system through the user interface, a portion of a value of the address LOV; and
in response to receiving the portion of the value, providing one or more suggestions for completing the value of the address LOV, wherein the one or more suggestions are filtered based on the received portion of the value and any other received values from the address LOV.

9. The method of claim 6, wherein using the configured address LOV in the user interface of the application to define values for attributes related to entry of an address within the selected geographic region further comprises:
receiving, by the computer system through the user interface, a selection of a value for one of the attributes associated to the address LOV; and
in response to receiving the selection, populating the values of one or more attributes associated to address LOV other than the attribute associated to the selected value.

10. A system comprising:
a processor; and
a memory coupled with and readable by the processor and storing a set of instructions which, when executed by the processor, cause the processor to configure and use an enhanced address List of Values (LOV) by:
installing an application using address information, the address information having a predefined format for a plurality of geographic regions relevant to the application;
configuring the address LOV for a selected geographic region from the plurality of geographic regions relevant to the application; and
using the configured address LOV in a user interface of the application to define values for attributes related to entry of an address within the selected geographic region.

11. The system of claim 10, wherein configuring the address LOV for the selected geographic region comprises:
obtaining geographic information specific to the selected geographic region; and
associating the obtained geographic information to the address LOV for the selected geographic region.

12. The system of claim 11, wherein configuring the address LOV for the selected geographic region further comprises:
reading a set of predefined configuration information for the address LOV;
presenting a configuration user interface proving at least some of the obtained geographic information and predefined configuration information;
receiving through the user interface one or more updates to the configuration information, wherein the one or more updates to the configuration information comprise updates to one or more of defined fields for the address LOV, defined styles for the address LOV, alternate names for values of attributes in the address LOV, mappings of the geographic data to attributes in the address LOV, an auto-populate function, or a filter function; and
storing the one or more updates to the configuration information.

13. The system of claim 12, wherein using the configured address LOV in the user interface of the application to define values for attributes related to entry of an address within the selected geographic region comprises:
reading the stored configuration information and the geographic information for the selected geographic region;
generating the user interface based on the configuration information and the geographic information, the user interface including one or more indications of address attributes and an associated control allowing selection of a value from the address LOV for the associated address attribute; and
displaying the generated user interface.

14. The system of claim 13, wherein using the configured address LOV in the user interface of the application to define values for attributes related to entry of an address within the selected geographic region further comprises:
receiving through the user interface an indication of one or more selected values from the address LOV and a request for a search; and
in response to the request, performing the search based on the one or more selected values from the address LOV.

15. The system of claim 13, wherein using the configured address LOV in the user interface of the application to define values for attributes related to entry of an address within the selected geographic region further comprises:
receiving, by the computer system through the user interface, a portion of a value of the address LOV; and
in response to receiving the portion of the value, providing one or more suggestions for completing the value of the address LOV, wherein the one or more suggestions are filtered based on the received portion of the value and any other received values from the address LOV.

16. The system of claim 13, wherein using the configured address LOV in the user interface of the application to define values for attributes related to entry of an address within the selected geographic region further comprises:
receiving, by the computer system through the user interface, a selection of a value for one of the attributes associated to the address LOV; and
in response to receiving the selection, populating the values of one or more attributes associated to address LOV other than the attribute associated to the selected value.

17. A computer-readable memory storing a set of instructions which, when executed by the processor, cause the processor to configure and use an enhanced address List of Values (LOV) by:
installing an application using address information, the address information having a predefined format for a plurality of geographic regions relevant to the application;
configuring the address LOV for a selected geographic region from the plurality of geographic regions relevant to the application; and
using the configured address LOV in a user interface of the application to define values for attributes related to entry of an address within the selected geographic region.

18. The computer-readable memory of claim 17, wherein configuring the address LOV for the selected geographic region comprises:
obtaining geographic information specific to the selected geographic region; and
associating the obtained geographic information to the address LOV for the selected geographic region.

19. The computer-readable memory of claim 18, wherein configuring the address LOV for the selected geographic region further comprises:
reading a set of predefined configuration information for the address LOV;
presenting a configuration user interface proving at least some of the obtained geographic information and predefined configuration information;
receiving through the user interface one or more updates to the configuration information, wherein the one or more updates to the configuration information comprise updates to one or more of defined fields for the address LOV, defined styles for the address LOV, alternate names for values of attributes in the address LOV, mappings of the geographic data to attributes in the address LOV, an auto-populate function, or a filter function; and
storing the one or more updates to the configuration information.

20. The computer-readable memory of claim 19, wherein using the configured address LOV in the user interface of the application to define values for attributes related to entry of an address within the selected geographic region comprises:
reading the stored configuration information and the geographic information for the selected geographic region;
generating the user interface based on the configuration information and the geographic information, the user interface including one or more indications of address attributes and an associated control allowing selection of a value from the address LOV for the associated address attribute; and
displaying the generated user interface.
